(19) United States
(12) Patent Application Publication
(10) Pub. No.: US 2024/0098283 A1
(43) Pub. Date: Mar. 21, 2024

(54) SELECTIVELY ENCODING OR DECODING PIXELS OF AN IMAGE VIA RUN-LENGTH ENCODING OR DECODING OR GRADIENT ENCODING OR DECODING

(71) Applicant: Microchip Technology Incorporated, Chandler, AZ (US)

(72) Inventors: Thorsten Kummermehr, Ubstadt-Weiher (DE); Martin Miller, Karlsruhe (DE); Jan Huber, Karlsruhe (DE)

(21) Appl. No.: 18/471,047

(22) Filed: Sep. 20, 2023

Related U.S. Application Data
(60) Provisional application No. 63/376,407, filed on Sep. 20, 2022.

(51) Int. Cl. H04N 19/186; G06V 10/75

(52) U.S. Cl. CPC H04N 19/186; G06V 10/751

(57) ABSTRACT

One or more examples relate to selectively line-based encoding pixels of an image via run-length encoding or gradient encoding. A method includes, for at least a portion of an image, determining a highest number of: a number of pixels in a run compressible via run-length encoding, and a number of pixels in a run compressible via gradient encoding; and selectively encoding at least some pixels of an image via the one of run-length encoding or gradient encoding corresponding to the determined highest number.

### CROSS-REFERENCE TO RELATED APPLICATION

This application claims the benefit under 35 U.S.C. § 119(e) of the priority date of U.S. Provisional Patent Application Ser. No. 63/376,407 filed Sep. 20, 2022, for LOSSLESS COMPRESSION ENCODING AND DECODING FOR IMAGES WITH RELATED APPARATUS AND METHODS, the contents and disclosure of which is incorporated herein in its entirety by this reference.

### FIELD

Examples relate to image encoding and decoding, and more specifically, selectively encoding or decoding portions of an image via gradient encoding or decoding or run-length encoding or decoding.

### BACKGROUND

Image encoding is the process of converting image data into a specific format or representation, often to facilitate storage, transmission, or compression, and often for applications that utilize the same.

### BRIEF DESCRIPTION OF THE DRAWINGS

FIG. 1 is a flow diagram depicting a process of encoding an image via run-length encoding or gradient encoding.

FIG. 2 illustrates an example process for determining the highest number of: the number of pixels in a run compressible via run-length encoding, and the number of pixels in a run compressible via gradient encoding, in accordance with one or more examples.

FIG. 3 illustrates an example process for determining the number of pixels in a run compressible via run-length encoding, in accordance with one or more examples.

FIG. 4 illustrates an example process for determining the number of pixels in a run compressible via gradient encoding, in accordance with one or more examples.

FIG. 5 illustrates an example process for transmitting an encoded line of image data, in accordance with one or more examples.

FIG. 6 is a block diagram depicting an example of a portion of a transmission that includes encoded image data, in accordance with one or more examples.

FIG. 7 illustrates an example process for decoding an image, in accordance with one or more examples.

FIG. 8 illustrates an example process for decoding an encoded line of image data, in accordance with one or more examples.

FIG. 9 is a flow diagram illustrating a process of compressing image data in accordance with one or more examples.

FIG. 10 is a flow-diagram depicting an example process for a subroutine for determining a number of pixels in a run compressible via run-length encoding for each pixel value in image data, in accordance with one or more examples.

FIG. 11 is a flow-diagram depicting an example process for a subroutine for determining a number of pixels in a run compressible via gradient encoding for each difference value exhibited by image data, in accordance with one or more examples.

FIG. 12 is a block diagram depicting a system in accordance with one or more examples.

FIG. 13 is a block diagram depicting an apparatus 1300 to encode a line of image data via run-length encoding or gradient encoding, in accordance with one or more examples.

FIG. 14 illustrates non-limiting examples of implementations of functional elements disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean the structures or components are identical in size, composition, configuration, or any other property.

The following description may include examples to help enable one of ordinary skill in the art to practice the disclosed embodiments. The use of the terms “exemplary,” “by example,” and “for example,” means the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

For many applications images may be transmitted from a source (e.g., camera, storage device) to a sink (e.g., display or algorithm). For many applications, lossless transmission of data (image data or other data) is mandatory, such as safety relevant applications, without limitation. Transmitting an image pixel-by-pixel (e.g., transmitting image data pixel value by pixel value, without limitation) is typically bandwidth intensive. Lossless compression decreases bandwidth and substantially ensures that no image data is lost or changed in a manner that requires correction.

Typical algorithms that encode or decode image data are computationally intensive and power hungry, and are unsuitable for low-power devices such as embedded microcontrollers. To reduce computational effort and power consumption, some algorithms targeted for embedded applications limit the highest compression ratio utilized by an algorithm. Limiting the highest possible compression ratio may, as non-limiting examples: reduce processing time, reduce memory usage, reduce complexity of arithmetic, or reduce a need for hardware accelerators, without limitation. Algorithms that limit the highest compression ratio may not achieve a suitable compression rate.

In networking applications (e.g., Ethernet, without limitation), some transmission protocols mandate line-by-line (encoding “line-by-line” is also referred to as “scanline encoding”) transmission of image data. However, some algorithms do not consider line boundaries in an image or image data.

Run-length encoding is the process of representing runs of data having the same value, or pattern of values, utilizing a value, or pattern of values, and a count. In the context of encoding image data, run-length encoding is the process of representing runs of pixels having the same pixel value as a single data value and a count. Run-length encoding is particularly effective when portions of an image have uniform color. The inventors of this disclosure appreciate RLE is also effective when portions of an image have uniform color, repeating patters, or both. In one or more examples, In the case of patterns of values, or repeating patterns, a symbol may be utilized to identify the pattern. The symbol may be identified in an index or dictionary that associates symbols and patterns. A decoder with an index or dictionary that associates the symbol with the pattern may decode the symbol.

Gradient encoding, sometimes called “difference encoding,” is the process of representing pixels in an image by the difference between pixel values of adjacent pixels (rather than the absolute pixel values) thereby utilizing a reduced number of bits. Runs of pixels having the same difference in pixel value may be represented as a pixel value and a count. Many natural images have smooth transitions (small delta pixel-to-pixel values), and so encoding the differences between adjacent pixels may result in compressed data.

Run-length encoding and gradient encoding may be applied line-by-line (encoding “line-by-line” is also referred to as “scanline encoding”) or to an entire image.

A “run” is one or more sequential data elements from a set of data elements. A “run length” of a run is the number of data elements in the run. In one or more examples, data elements of a run may, or may not, be consecutive in the set of data elements. In one or more examples, a data element may be a pixel value or a difference between two pixel values.

Generally speaking, gradient encoding is more computationally expensive than run-length encoding because gradient encoding involves subtraction for every pixel and storing a difference between a pixel and a next pixel, while run-length encoding involves scanning an image pixel-by-pixel and counting repetitions. However, in images that exhibit long, smooth transitions, gradient encoding results in higher compression ratios than run-length encoding.

One or more examples relate, generally, to encoding image data in portions utilizing run-length encoding or gradient encoding. For a respective image data, the number of pixels in a run compressible via run-length encoding is determined and the number of pixels in a run compressible via gradient encoding is determined. The higher of the determined number of pixels in a run compressible via run-length encoding and the determined number of pixels in a run compressible via gradient encoding is determined. The encoding scheme, run-length encoding or gradient encoding, corresponding to the higher of the determined number of pixels in a run is utilized to encode a portion of image data. The number of pixels encoded in the portion of image data may correspond to the determined number of pixels in a run compressible for the utilized encoding scheme. Image data may be processed iteratively until, as non-limiting examples, a line of image data is encoded or an entire image of image data is encoded.

In one or more examples, for a given line of image data, the numbers of pixels in respective runs compressible via run-length encoding are determined, and the highest number of pixels in a single one of the respective runs compressible via run-length encoding is determined. For the given line of image data, the numbers of pixels in respective runs compressible via gradient encoding are determined, and the highest number of pixels in a single one of the respective runs compressible via gradient encoding is determined. The encoding scheme corresponding to the higher of the highest number of pixels in the single run compressible via run-length encoding and the highest number of pixels in the single run compressible via gradient encoding is utilized to encode line of image data. This process may be performed iteratively until a totality of lines of image data are encoded.

In one or more examples, any suitable means for expressing the number of pixels may be utilized without exceeding the scope of this disclosure. As a non-limiting example, a number of pixels may be expressed as a value that represents an amount of pixels, such as a count (e.g., 1, 2, 3, . . . 10, . . . 100 pixels, without limitation), a quantity (e.g., bytes used to represent pixel values, without limitation); a value that represents a density of pixels (e.g., pixels-per-inch, without limitation); or a fraction of a total (e.g., 1/100, 1/10, ¼, or ½ of pixels in a line of image data or a scene represented by an image, without limitation).

In one or more examples, the numbers of pixels in a run compressible via run-length encoding or gradient encoding may be counted, measured, or calculated directly. In other examples, proxy values for the number of pixels in the single run compressible via run-length encoding or gradient encoding may be utilized. As a non-limiting example, the number of runs per line for run-length encoding and gradient encoding may be determined and the encoding scheme with the fewest number of runs may be selected. Using the encoding scheme that encodes the line with the fewest number of runs means the fewer runs are utilized to represent the line of image data and so more compactly than the alternative encoding scheme.

Examples discussed herein may be particularly suited to grayscale image encoding. A grayscale image is an image in which the value of each pixel represents only an amount of light. Thus, a pixel value only represents intensity. Greyscale images are distinct from one-bit bi-tonal black-and-white images, which in the context of computer imaging are images with only two colors: black and white. In a grayscale image, respective pixels may have, as a non-limiting example, a value ranging from 0 (black) to 255 (white) for 8-bit images. Use of other pixel value ranges does not exceed the scope of this disclosure. The values in between represent varying shades of gray (i.e., amount of light present).

Since the pixel values in grayscale images only represent intensity, i.e., amount of light, in the case of a natural image captured by a still or moving image capture device portions of the image nearer a light source exhibit more captured light than portions of an image farther from the light source. In an image of a natural scene, some portions of the image further away from a light source may exhibit uniform light intensity (a uniform pixel value) and some portions of the image closer to a light source may exhibit less uniform or varying light intensity (varying pixel values). As discussed above, run-length encoding may be particularly suited for the portions of the image exhibiting uniform pixel values and gradient encoding may be particularly suited for portions of the images exhibiting smoothly varying pixel values.

One or more examples relate to a scanline encoder that offers both run-length encoding and gradient encoding, and selectively applies run-length encoding or gradient encoding to a line of a gray scale image so as to provide improved compression.

Image processing applications such as for detecting moving objects or light patterns often use greyscale images generated by cameras or computed based on information captured or generated by cameras. For example, a modern automobile headlight (i.e., an entire lighting assembly at the front of the vehicle, which can include one or more of a main beam, a dipped beam, a turn signals, and optionally other lights) includes a camera. The headlight camera typically has a high resolution (>16 k pixel) and a refresh rate of at least 60 frames-per-second (fps). A headlight-unit or zonal controller transmits an 8-Bit grayscale image to a device controlling the headlight using a transmission protocol (e.g., RFC4175, without limitation) over an Ethernet physical layer. The bandwidth to transmit a 32,000 pixel, 8-bit/pixel image is 23,000 pixel *8-bit/pixel*60 fps=15.36 Mbps. RFC4175 mandates line-by-line transmission. Compression is helpful, but functional safety mandates lossless data compression.

One or more examples relate, generally, to an image capture system that includes a grayscale image capture device and a scanline encoder that selectively applies run-length encoding or gradient encoding to a grayscale image generated by the image capture device so as to provide improved compression. In one or more examples, the image capture system may be included in an automobile headlight.

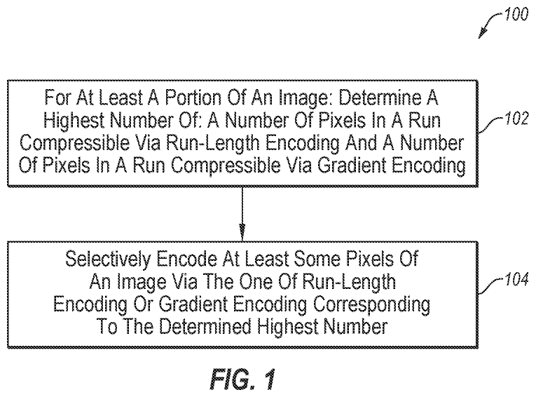

FIG. 1 is a flow diagram depicting a process 100 of encoding an image via run-length encoding or gradient encoding.

Although the example process 100 depicts a particular sequence of operations, the sequence may be altered without departing from the scope of the present disclosure. For example, some of the operations depicted may be performed in parallel or in a different sequence that does not materially affect the function of the process 100. In other examples, different components of an example device or system that implements the process 100 may perform functions at substantially the same time or in a specific sequence.

According to one or more examples, process 100 includes, for at least a portion of an image, determining a highest number of: a number of pixels in a run compressible via run-length encoding and a number of pixels in a run compressible via gradient encoding at operation 102. In one or more examples, process 100 may include determining the number of pixels per run compressible via run-length encoding, and the number of pixels per run compressible via gradient encoding. Process 100 may include determining the highest number of pixels in a run compressible via run-length encoding, and the highest number of pixels in a run compressible via gradient encoding. Process 100 may include determining the highest one of the highest number of pixels in a run compressible via run-length encoding and the highest number of pixels in a run compressible via gradient encoding.

According to one or more examples, process 100 includes selectively encoding at least some pixels of an image via the one of run-length encoding or gradient encoding corresponding to the determined highest number of pixels in a run compressible at operation 104. In one or more examples, the number of pixels encoded at operation 104 corresponds to a totality of pixels in a line of the image. In one or more examples, the number of pixels encoded at operation 104 may correspond to a portion of a line. The portion of the line may include a number of pixels that is the highest number of pixels in a run determined in operation 102.

Process 100 may optionally include selectively encoding remaining pixels of the image via one or more of run-length encoding or gradient encoding at least partially based on respective determined highest numbers of pixels in single runs compressible via run-length encoding or gradient encoding. Process 100 may optionally include transmitting the image over a network, the image comprising a portion of image data encoded via run-length encoding and a portion of image data encoded via gradient encoding.

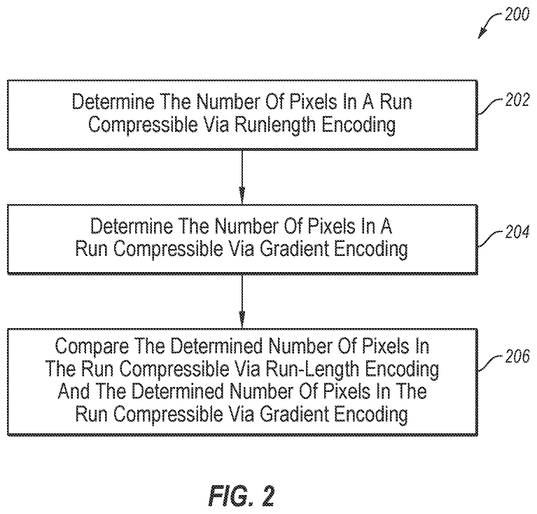

FIG. 2 illustrates an example process 200 for determining the highest number of: the number of pixels in a run compressible via run-length encoding, and the number of pixels in a run compressible via gradient encoding, in accordance with one or more examples.

Although the example operation 200 depicts a particular sequence of operations, the sequence may be altered without departing from the scope of the present disclosure. For example, some of the operations depicted may be performed in parallel or in a different sequence that does not materially affect the function of the operation 200. In other examples, different components of an example device or system that implements the operation 200 may perform functions at substantially the same time or in a specific sequence.

According to one or more examples, process 200 includes determining the number of pixels in a run compressible via run-length encoding at operation 202. In one or more examples, this determination is made for a respective line of an image.

According to one or more examples, process 200 includes determining the number of pixels in a run compressible via gradient encoding at operation 204. In one or more examples, this determination is made for the same respective line of the image as operation 202.

According to one or more examples, process 200 includes determining the highest number of: the number of pixels in a run compressible via run-length encoding, and the number of pixels in a run compressible via gradient encoding at operation 206. Any suitable technique may be utilized to determine the highest number. As non-limiting examples, numbers of pixels in respective runs may be counted and compared; amount of data compressible in respective runs may be determined and compared, numbers of respective runs compressible via run-length and gradient encoding may be determined and the encoding scheme corresponding to the fewest number of runs chosen; and combinations and sub-combinations of the same.

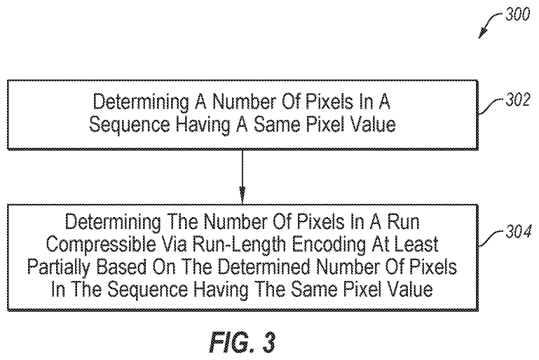

FIG. 3 illustrates an example process 300 for determining the number of pixels in a run compressible via run-length encoding, in accordance with one or more examples.

Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to one or more examples, process 300 includes determining a number of pixels in a sequence of pixels having a same pixel value at operation 302. In one or more examples, process 300 may count the number of pixels in a sequence having the same respective pixel value. In a case where a totality of a line of image data is to be encoded using run-length encoding or gradient encoding, process 300 may determine, for the line, the numbers of pixels in respective sequences having the same respective pixel values.

Respective sequences of pixels compressible by one of the respective encoding algorithms are a “run,” and the number of pixels in a run is the “run-length.” A respective line may exhibit multiple runs of pixel values, and process 300 may determine respective run-lengths for multiple respective runs in a respective line.

According to one or more examples, process 300 includes determining the number of pixels in a run compressible via run-length encoding at least partially based on the determined number of pixels in the sequence having the same pixel value at operation 304. In a case where a totality of a line of image data is to be encoded using run-length encoding or gradient encoding and a respective line exhibits multiple runs, process 300 may select the longest run length (run having the highest number of pixels) and use that number as the number of pixels in a run compressible via run-length encoding.

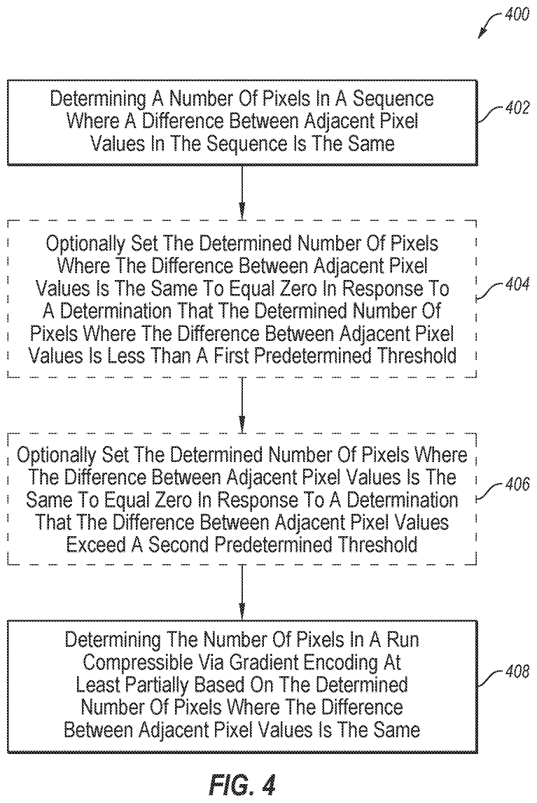

FIG. 4 illustrates an example process 400 for determining the number of pixels in a run compressible via gradient encoding, in accordance with one or more examples.

Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to one or more examples, process 400 includes determining a number of pixels in a sequence where a difference between adjacent pixel values in a sequence is the same at operation 402. In one or more examples, process 400 may include counting, for a respective line of the image, wherein the sequence is the pixels in the respective line, the number of consecutive pixels exhibiting a same difference between adjacent pixel values. Respective sets of such consecutive pixels exhibit a constant change, and the number of consecutive pixels exhibiting the constant change is the length of a run of constant change. A line of image data may exhibit multiple runs of constant change, and so process 400 may determine respective lengths for multiple respective constant changes of runs of constant change in a respective line.

According to one or more examples, process 400 optionally includes setting the determined number of pixels where the difference between adjacent pixel values is the same to zero in response to, and to indicate, a determination that a determined number of pixels where the difference between adjacent pixel values is the same does not exceed a predetermined threshold. In one or more examples, the predetermined threshold represents a number of pixels in a run compressible via gradient encoding that is predetermined to provide an improvement over run-length encoding—notwithstanding that the number of pixels compressible via gradient encoding in a single run may be higher than the number of pixels compressible via run-length encoding in a single run for a given instance of the algorithm. When the threshold is reached gradient encoding may provide an improvement over run-length encoding. In response to a determination that, in a respective run, the number does not exceed the predetermined threshold, process 400 may include, as a non-limiting example, return a zero (e.g., a zero for number of pixels in a run encodable via gradient encoding, without limitations) so that in process 100 or process 200 run-length encoding is chosen for that portion of the image data. Additionally or alternatively, process 400 may return a NULL (or other suitable indication) to indicate the predetermined threshold was not reached and so process 100 or process 200 may default to run-length encoding for that portion of the image data.

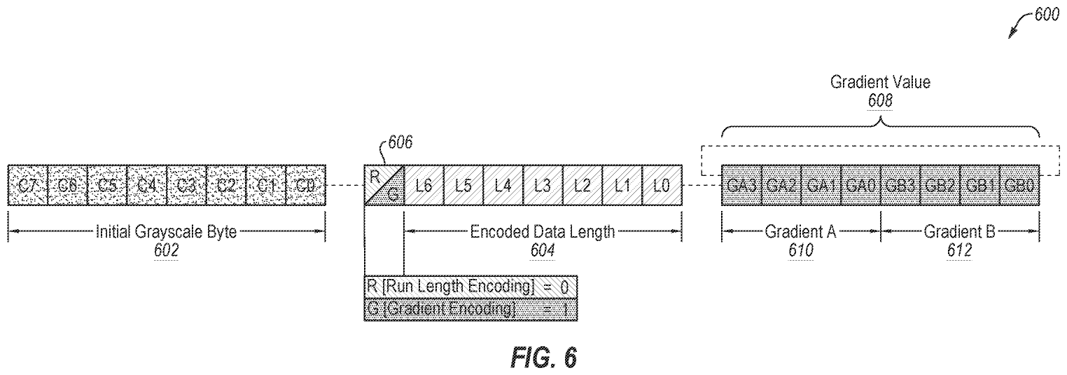

According to one or more examples, process 400 optionally includes setting the determined number of pixels where the difference between adjacent pixel values is the same to zero or NULL in response to, and to indicate, a determination that difference between adjacent pixel values exceeds a second predetermined threshold at operation 406. In one or more examples, the second predetermined threshold may represent an upper limit on a difference in pixel values that may be presented, for example, in a transmission such as transmission 600 of FIG. 6. In one or more examples, the upper limit may be determined by a number of bits available to represent the difference in pixel values. In the non-limiting example depicted by FIG. 6, two 4-bit two's complement numbers are used to a difference in pixel values of a run encoded via gradient encoding. The two 4-bit numbers represent a difference of −8 to 7 or −7 to 8. If a difference between two adjacent pixels is greater than the second predetermined threshold, gradient encoding is not used and the determined number of pixels where the difference between adjacent pixel values is the same is set to zero or NULL. The second predetermined threshold may be chosen, as a non-limiting example, based on specific operating conditions such as number of bits available to represent the difference in pixel values (use of more or fewer bits to represent the difference does not exceed the scope of this disclosure), or a convention used to represent the number (e.g., two's complement, without limitation), without limitation.

According to one or more examples, process 400 includes determining the number of pixels in a run compressible via gradient encoding at least partially based on the determined number of pixels where the difference between adjacent pixel values in the sequence is the same at operation 408. In a case where a respective line of image data exhibits multiple constant changes, process 400 may select the longest run length and use that number as the number of pixels in a run compressible via gradient encoding.

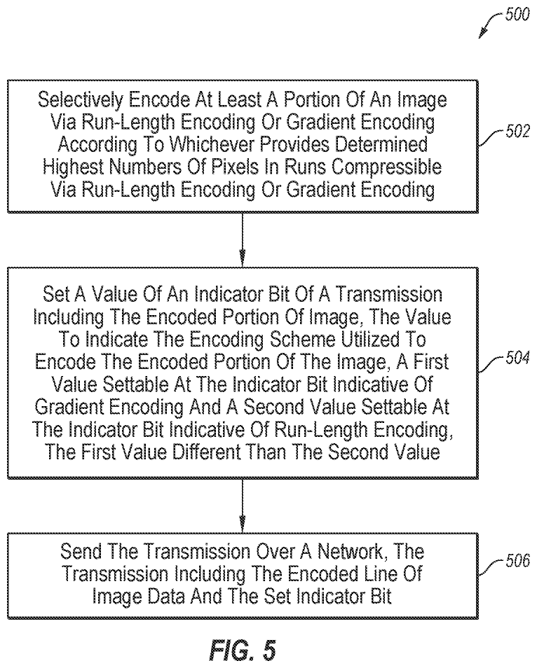

FIG. 5 illustrates an example process 500 for transmitting an encoded line of image data, in accordance with one or more examples.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to one or more examples, the process 500 includes selectively encoding a portion of an image via run-length encoding or gradient encoding according to whichever provides determined highest numbers of pixels in runs compressible via run-length encoding or gradient encoding at operation 502. In one or more examples, process 500 may encode the line of image data in accordance with one or more of process 100, process 200, process 300 or process 400.

According to one or more examples, the process 500 includes setting a value of an indicator bit of a transmission including an encoded portion of an image at operation 504, the value of the indicator bit to indicate the encoding scheme utilized to encode the encoded portion of the image. A first value settable at the indicator bit indicative of gradient encoding and a second value settable at the indicator bit indicative of run-length encoding, the first value different than the second value. In one or more examples, a first value of the indicator bit (e.g., a ‘0’ or a ‘1’) is indicative of gradient encoding and a second value of the indicator bit (e.g., the other of a ‘0’ or a ‘1’) is indicative of run-length encoding. In one or more examples, a bit of a real-time transport protocol (RTP) frame may be utilized as an indicator bit. RTP typically involves sending lines of uncompressed image and video data, so there may be unutilized bits due to the reduced size of the encoded line of image data.

According to one or more examples, the process 500 includes sending the transmission over a network, the transmission including the encoded line of image data and the set indicator bit. In one or more examples, the transmission may have a format according to the RTP Payload Format for Uncompressed Video, except the line of image data may be encoded/compressed according to operation 502.

FIG. 6 is a block diagram depicting an example of a portion of a transmission 600 (also referred to herein as a “transmission portion 600”) for sending encoded image data, in accordance with one or more examples.

Transmission portion 600 includes fields for grayscale byte 602, encoded data length 604, and gradient value 608. The field for encoded data length 604 includes a bit for indicator bit 606. The field for gradient value 608 includes respective sub-fields for a first component 610 and a second component 612.

Grayscale byte 602 is the value of a byte in a respective line of image data. Encoded data length 604 is the length or number of pixels represented in this encoding. In the case of run length encoding, the value of encoded data length 604 represents the length of the run for the value stored in grayscale byte 602. Indicator bit 606 indicates run-length encoding or gradient encoding. If indicator bit 606 indicates gradient encoding, then grayscale byte 602 is the value of the initial byte of the line of image data. The field for first component 610 and the field for second component 612 respectively store signed 4-bit values (using two's complement notation) that, together, represent a difference between grayscale values.

In one or more examples, image data encoded in accordance with one or more examples may be recovered by processing the encoded image data utilizing the decoding algorithm that corresponds to the encoding algorithm. Any suitable technique may be utilized to indicate (e.g., indicate to the decoder, without limitation) the encoding algorithm utilized to encode a respective line of encoded image, namely, run-length encoding or gradient encoding. Notably, any scanline gradient decoder scanline run-length decoder may be utilized once the appropriate decoder has been identified.

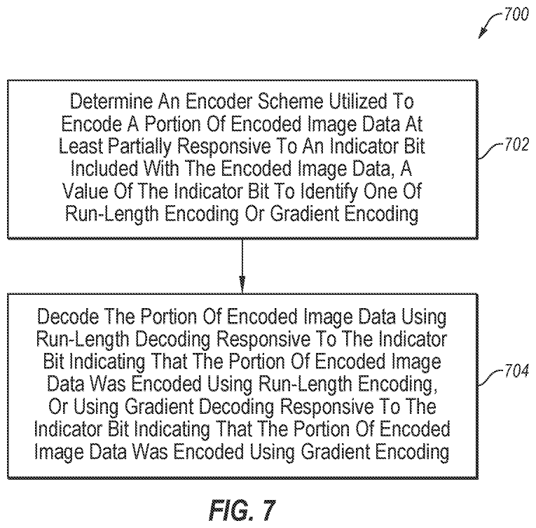

FIG. 7 illustrates an example process 700 for decoding an image, in accordance with one or more examples.

Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

According to one or more examples, process 700 includes determining an encoder scheme utilized to encode a portion of encoded image data at least partially responsive to an indicator bit included with the encoded image data at operation 702. In one or more examples, a value of the indicator bit is used to indicate run-length encoding or gradient encoding. A first value of the indicator bit indicates run-length encoding and a second value of the indicator bit indicates gradient encoding. In one or more examples, the indicator bit may be associated with the portion of encoded image data. As a non-limiting example, the indicator bit may be associated with the portion of encoded image data based on a predetermined format for a packet or frame for sending the portion of encoded image data. For example, the location of the indicator bit in a transmission pre-associated with a location in the transmission that included the portion of encoded image data. As a non-limiting example, indicator bit 606 is the first bit of the field for encoded data length 604 of transmission 600 and it is pre-associated with the field for the gradient value 608 of FIG. 6.

According to one or more examples, process 700 includes decoding the portion of encoded image data using run-length decoding responsive to the indicator bit indicating the portion of encoded image data was encoded using run-length encoding; or gradient decoding responsive to the indicator bit indicating the portion of encoded image data was encoded using gradient encoding at operation 704.

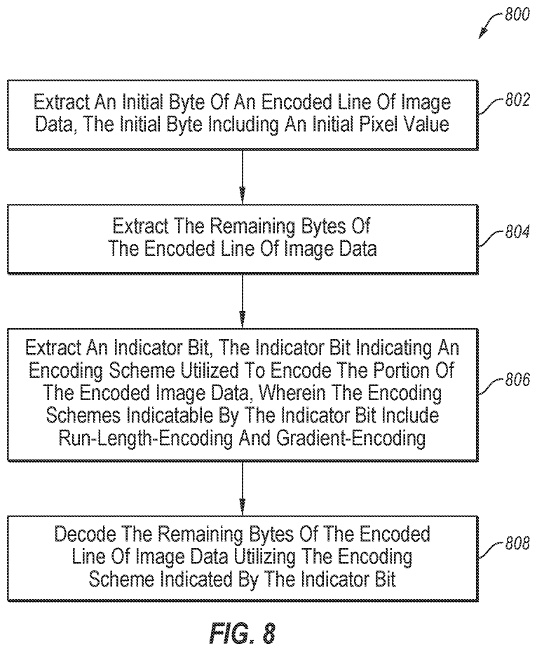

FIG. 8 illustrates an example process 800 for decoding an encoded line of image data, in accordance with one or more examples.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to one or more examples, process 800 includes obtaining (e.g., extracting via processing, without limitation) a pixel value from a portion of encoded image data at operation 802. In one or more examples, the pixel value may be obtained from a predetermined byte of the encoded image data such as the initial byte of the encoded image data, without limitation.

According to one or more examples, process 800 includes obtaining (e.g., extracting via processing, without limitation) an encoded data length value from the portion of encoded image data at operation 804. In one or more examples, the encoded data length value may be obtained from one or more predetermined bytes of the encoded image data such as the next N byes (where N is an integer greater than 1) consecutively after a predetermined byte including the pixel value, without limitation.

According to one or more examples, process 800 includes obtaining an indicator value, the indicator value indicating an encoding scheme utilized to encode the portion of the encoded image data at operation 806. The encoding schemes indicatable by the indicator value include run-length-encoding and gradient-encoding. In one or more examples, the indicator value may be obtained from an indicator bit included with the portion of encoded image data. In one or more examples, the indicator bit may be a bit of the portion of encoded image data or may be a bit of a transmission (e.g., one or more packets, without limitation) that included the portion of encoded image data.

According to one or more examples, process 800 includes decoding the portion of encoded image data via the encoding scheme indicated by the indicator, and decoding any remaining portions of encoded image data via one or more of run-length encoding or gradient encoding. at operation 808. In one or more examples, decoding the portion of encoded image data includes decoding via gradient encoding or run-length encoding, as indicated by the indicator. Process 800 may be performed to decode the remaining portions of image data, if any.

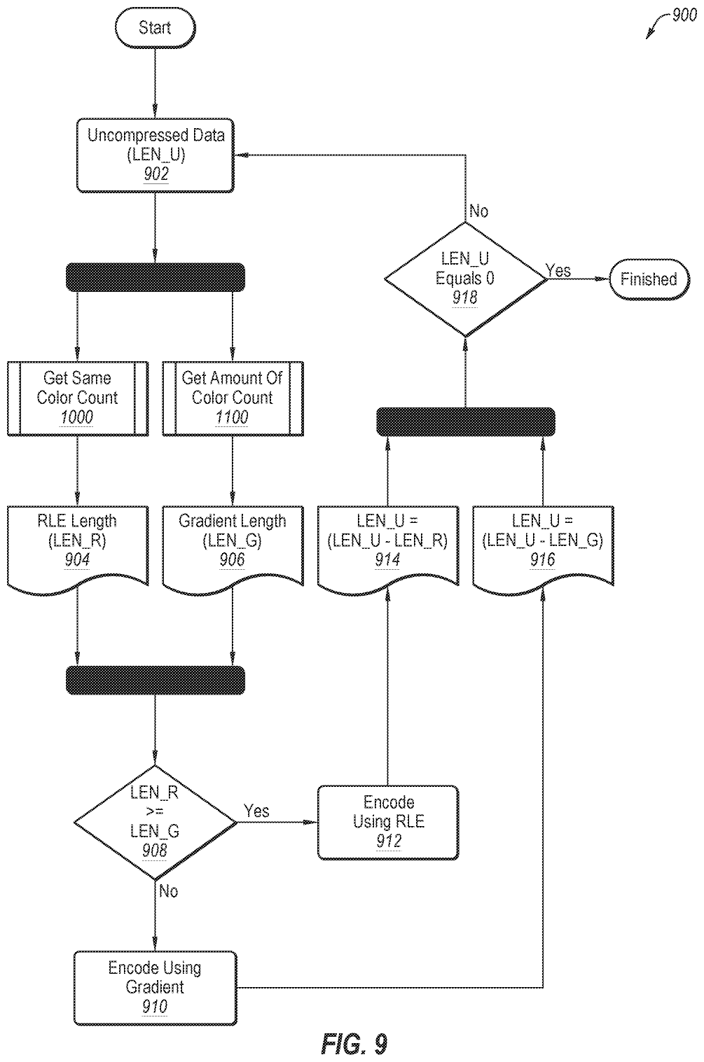

FIG. 9 is a flow diagram illustrating a process 900 of encoding image data in accordance with one or more examples.

At block 902, process 900 receives an uncompressed image data of length LEN_U (i.e., having included a number of pixels equal to LEN_U). In one or more examples, this is image data for a line of a grayscale image.

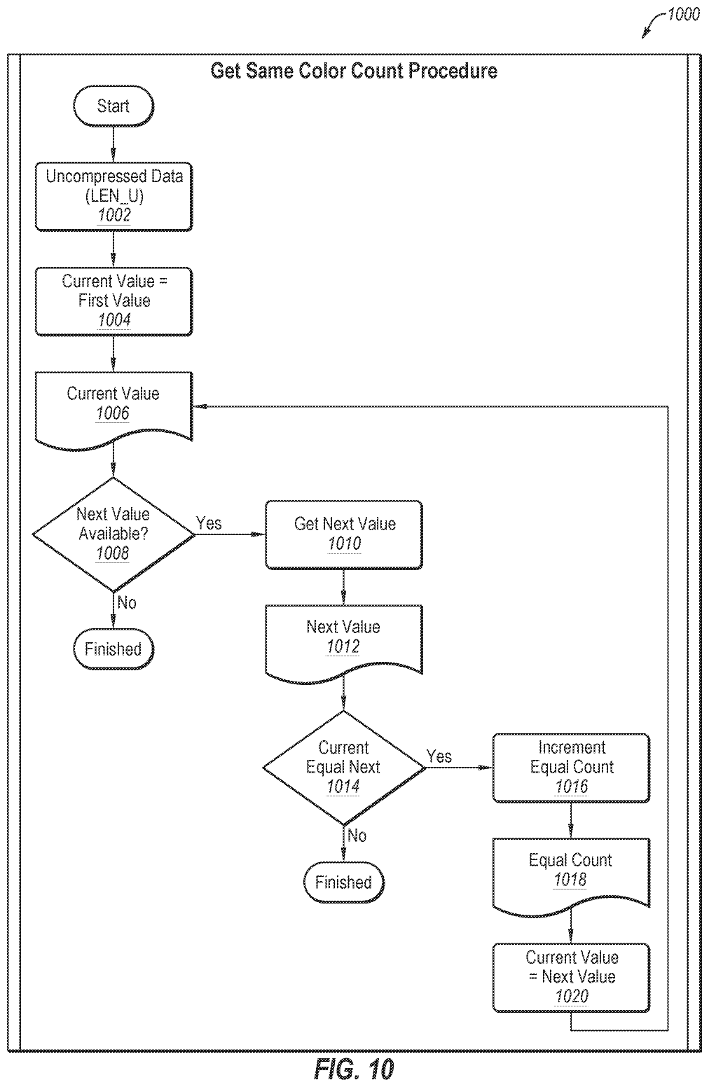

At block 1000, process 900 executes a subroutine (“subroutine 1000”) “get same color count” (where the term “color” is understood to be pixel value), which is a subroutine that determines and returns a value that represents the number of pixel in a run compressible via run-length encoding for each pixel value in the unencoded image data of length LEN_U. Subroutine 1000 is described, below, with reference to FIG. 10. In one or more examples, some or a totality of operations of subroutine 1000 may be performed by a run-length encoding circuit that also performs run-length encoding.

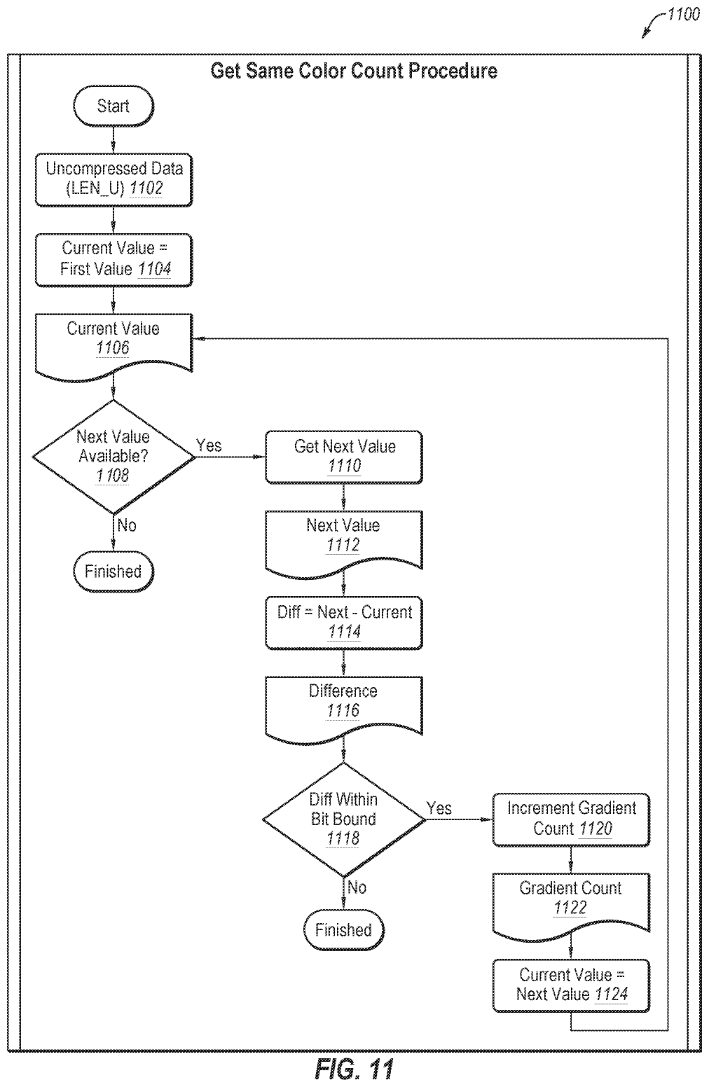

At block 1100, process 900 executes a subroutine (“subroutine 1100”) “get amount of color gradients.” which is a subroutine that determines and returns a number of pixels in a run compressible via gradient encoding for each difference value exhibited by the unencoded image data of length LEN_U. Subroutine 1100 is described, below, with reference to FIG. 11. Subroutine 1100 may be initialized and execute for a time duration that partially or totally overlaps with a time duration that subroutine 1000 executes, or a time duration that does not overlap with a time duration of subroutine 1000. In one or more examples, some or a totality of operations of subroutine 1100 may be performed by a gradient encoding circuit that also performs gradient encoding.

Block 904 receives the output of subroutine 1000 and determines the number of pixels in a run compressible via run-length encoding, where the number of pixels in a run compressible via run-length encoding for the encoded image data is denoted LEN_R. Block 906 receives the output of subroutine 1100 and determines the number of pixels in a run compressible via gradient encoding, where the number of pixels in a run compressible via gradient encoding for the unencoded image data is denoted LEN_G. Block 904 and block 906 my execute during respective time durations that substantially overlap.

At block 908, process 900 determines if LEN_R is greater than or equal to LEN_G. If “yes,” then process 900 advances to block 912, if “no” then process 900 advances to block 910. In one example, when the highest number of pixels in a run compressible via gradient encoding is equal to the highest number of pixels in a run compressible via run-length encoding, run-length encoding is preferred since payload since the gradient value need not be transmitted thereby saving bandwidth.

At block 912, process 900 encodes LEN_R amount of unencoded image data via run-length encoding. At block 914 process 900 subtracts the number of pixels in a run compressible via run-length encoding LEN_R from the number of pixels in unencoded image data LEN_U, and the result is the remaining number of unencoded pixels in the image data.

At block 910, process 900 encodes LEN_G amount of unencoded image data via gradient encoding. At block 916, subtracts the number of pixels in a run compressible via gradient encodings LEN_G from the number of pixels in unencoded image data LEN_U, and the result is the remaining number of unencoded pixels in the image data.

At block 918, process 900 determines whether or not the number of pixels of image data remaining=0 (i.e., whether the entire image has been encoded). If “no” then process 900 loops back to block 902. If “yes,” then process 900 encodes any remaining unencoded pixels—such as any single pixels where neither run-length encoding or gradient encoding were applied, without limitation—using RLE and ends.

FIG. 10 is a flow-diagram depicting a subroutine 1000 for subroutine 1000 for determining a number of pixels in a run compressible via run-length encoding for each pixel value in image data, in accordance with one or more examples.

At block 1002, subroutine 1000 receives unencoded image data of length LEN_U. At block 1004, subroutine 1000 executes a function to obtain the first pixel value of the unencoded image data, and sets a variable ‘current value’ equal to the output of the function. At block 1006, the function executed in block 1004 returns a pixel value stored in ‘current value,’ which can be compared with the next pixel value, if any.

At block 1008, subroutine 1000 determines if there is a next pixel value. If “no” then subroutine 1000 ends. If “yes,” then at block 1010, subroutine 1000 executes a function to obtain the next pixel value of the unencoded image data. At block 1012, subroutine 1000 receives and stores the output of the function in the variable “next value.” At block 1014, subroutine 1000 determines if current value equals next value. If “no” then the subroutine ends. If “yes,” then at block 1016, subroutine 1000 executes a function “increment equal counter,” which increments a variable “equal count” being utilized as a counter of the run-length. At block 1018, subroutine 1000 updates the value of equal counter (increments it by 1). At block 1020, subroutine 1000 sets current value equal to next value, effectively making the next value the current value, and then loops back to block 1006.

FIG. 11 is a flow-diagram depicting a subroutine 1100 for subroutine 1100 for determining a number of pixels in a run compressible via gradient encoding for each difference value exhibited by image data, in accordance with one or more examples.

At block 1102, subroutine 1100 receives unencoded image data of length LEN_U. At block 1104, subroutine 1100 executes a function to obtain the first pixel value of the unencoded image data, and sets a variable ‘current value’ equal to the output of the function. At block 1106, the function executed in block 1104 returns a pixel value stored in ‘current value,’ which can be compared with the next pixel value, if any.

At block 1108, subroutine 1100 determines if there is a next pixel value. If “no” then subroutine 1100 ends. If “yes,” then, at block 1110, subroutine 1100 executes a function to obtain the next pixel value of the unencoded image data. At block 1112, subroutine 1100 receives and stores the output of the function in the variable “next value.”

At block 1114, subroutine 1100 subtracts current value from next value and sets a variable “diff” equal to the result. At block 1116, subroutine 1100 stores the output of the difference operation in block 1114 in the variable “difference.”

At block 1118, subroutine 1100 determines whether or not the value of difference is within predetermined bit bounds. Bit bounds are the amount of bits used to store or transmit the gradient. If the number of bits needed to represent the value exceeds the number of bits available to store or transmit the gradient then gradient encoding is not usable in this instance, and as a result if “no,” then subroutine 1100 ends. If “yes,” then at block 1120, subroutine 1100 executes a function “increment gradient counter,” which increments a variable “gradient count” being utilized as a counter of the gradient length. At block 1122, subroutine 1100 updates the value of gradient counter (increments it by 1). At block 1124, subroutine 1100 sets current value equal to next value, effectively making the next value the current value, and then loops back to block 1106.

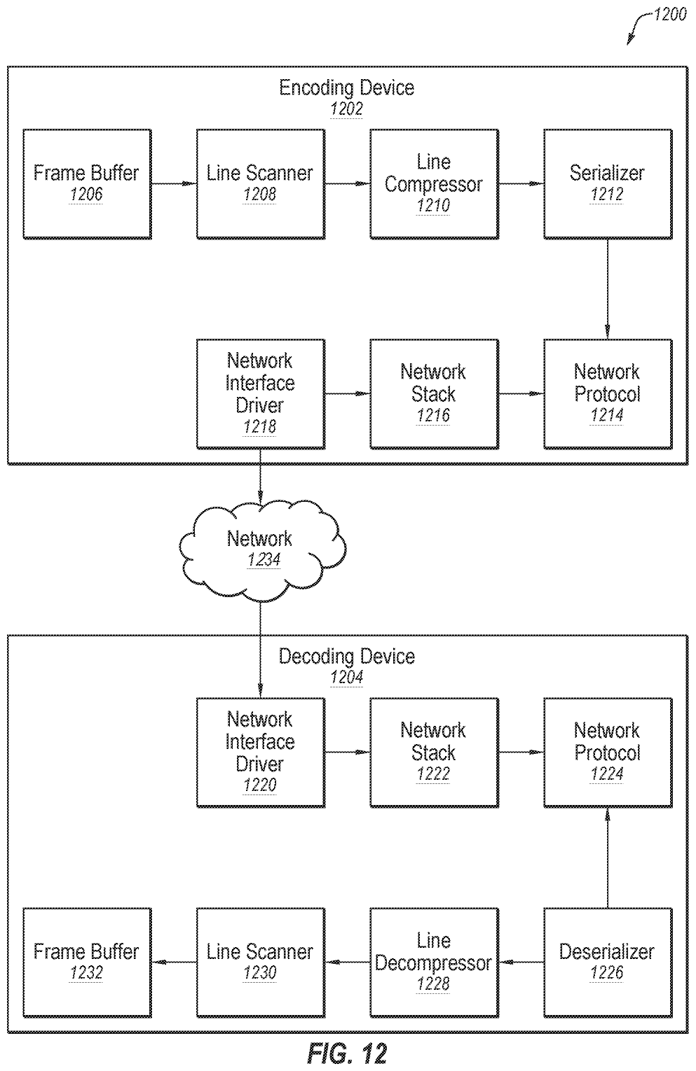

FIG. 12 is a block diagram depicting a system 1200 in accordance with one or more examples.

System 1200 includes an encoding device 1202, a network 1234 and a decoding device 1204. Encoding device 1202 comprises a frame buffer 1206, a line scanner 1208, a line compressor 1210, a serializer 1212, a network protocol 1214, a network stack 1216, and a network interface driver 1218. Decoding device 1204 comprises a network interface driver 1220, a network stack 1222, a network protocol 1224, a deserializer 1226, a line decompressor 1228, a line renderer 1230, and a frame buffer 1232.

Encoding device 1202 is a device or system that includes the encoder discussed herein, for example, a headlight unit or zonal controller of an automobile that includes an encoder and includes or is coupled with (e.g., for electrical communication, without limitation), an imager (e.g., an image capture device that includes a camera and optionally includes sensors (e.g., infra-red, sonar, lidar, without limitation), without limitation). In one or more examples, the imager may include an encoder discussed herein. Using the example of a headlight, the brightness may be controlled via a Pulse Width Modulation (PWM) signal generated at a controller (e.g., a headlight controller or automobile controller that includes headlight control functionality, without limitation) at least partially in response to the imager that captures and encodes an image of the resultant light, an image of the light from one or more other light sources (e.g., a headlight from another vehicle, without limitation), or both, without limitation. Discussion of headlights and automobiles is not intended to limit the scope of this disclosure in any way, and other applications do not exceed the scope of this disclosure. To change the brightness, the duty cycle (relative time between on and off) is changed (e.g., duty cycle decreased to increase brightness and increased to decrease brightness, or vice versa, without limitation).

Decoding device 1204 is a device that includes a decoder discussed herein, for example, the headlight controller mentioned above. Encoding device 1202 and decoding device 1204 communicate over network 1234, which may be, as a non-limiting example, an automotive network. When encoding device 1202 transmits encoded image data to decoding device 1204 via network 1234, encoding device 1202 may also be referred to as a “transmitter 1202,” and decoding device may also be referred to as a receiver 1204.

Frame buffer 1206 is a temporary storage device that holds a current frame (image data) to be encoded.

Line scanner 1208 scans the line of image stored in frame buffer 1206 line-by-line, for example, from top to bottom or bottom to top. Line scanner 1208 reads the line of image data from the frame buffer 1206 and prepares the read the line of image data for encoding.

Line compressor 1210 (which also may be referred to as a “line encoder 1210”) encodes the scanned line of image data to reduce the amount of data. Line compressor 1210 may execute some or a totality of operations of process 100, process 200, process 300, process 400, process 500, process 900, subroutine 1000, or subroutine 1100, discussed above.

Serializer 1212 converts the encoded line of image data into a serial format, i.e., a sequence of bits that can be transmitted over a network.

Network protocol 1214 defines the rules for how data (here, the encoded line of image data) will be sent over the network 1234. Network protocol 1214 structures the serialized, encoded, line of image data into packets or frames and adds headers and footers.

Network stack 1216 is a collection of software layers that prepares the serialized, encoded, line of image data for transmission over network 1234. Each layer has a specific responsibility, such as error-checking or addressing.

Network interface driver 1218 is a software component that interfaces with the physical network hardware (such as Ethernet or Wi-Fi, without limitation). Network interface driver 1218 takes the packets from the network stack 1216 and sends them out on the network 1234. Network protocol 1214, network stack 1216, and network interface driver 1218 are perform functions of network equipment for sending and receiving data over a network, including without limitation network 1234.

Network interface driver 1220 is software component interfaces with the hardware of network 1234 and receives the incoming data packets from the network 1234 that includes the serialized, encoded line of image data.

Network stack 1222 handles the incoming data packets from network 1234, including the serialized, encoded line of image data. Network stack 1222 extracts the data from the packets, checks for errors, and prepares it for further processing by upper layers.

Network protocol 1224 extracts the serialized data from the structured packets or frames. Network protocol 1224 understands the rules (headers, footers) set by the corresponding network protocol 1214 of encoding device 1202.

Network interface driver 1220, network stack 1222, and network protocol 1224 perform functions of network equipment for sending and receiving data over a network, including without limitation network 1234.

Deserializer 1226 does the opposite of serializer 1212 and converts the serialized, encoded line of image data back into a format suitable for decoding.

Line decompressor 1228 (which may also be referred to as “line decoder 1228”) decodes the line of image data back to its original format, reversing the work done by the line encoding in the encoder. Line decompressor 1228 performs some of a totality of operations of process 700, process 800, or 900.

Line renderer 1230 puts lines of image data received via network 1234 back together, recreating the image from the line data.

Frame buffer 1232 holds the reconstructed frame (image) after decoding. It can be likened to a canvas where the image information is displayed after processing.

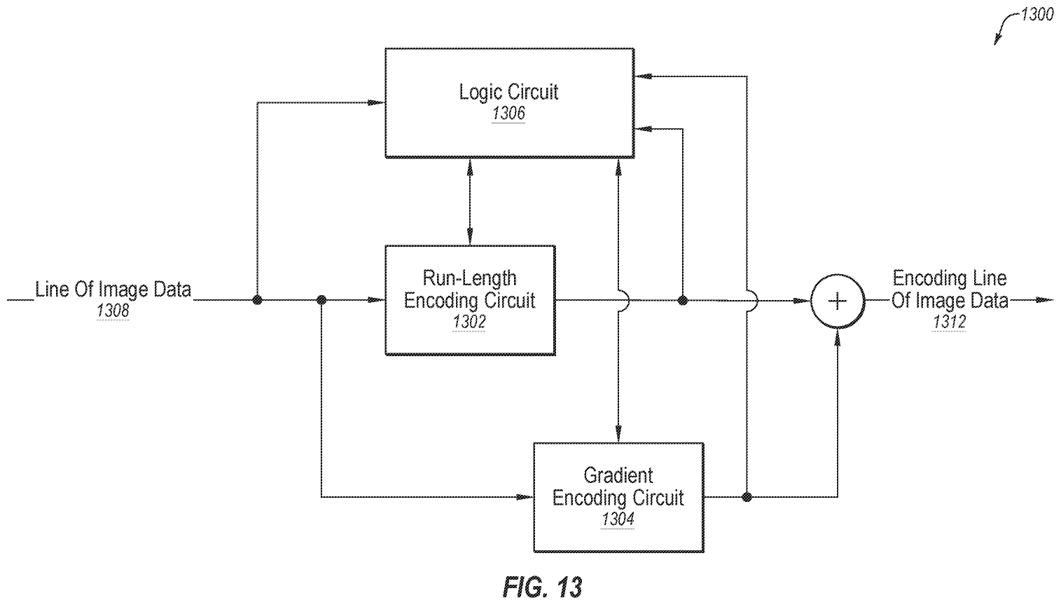

FIG. 13 is a block diagram depicting an apparatus 1300 to encode a line of image data via run-length encoding or gradient encoding, in accordance with one or more examples. In encoding examples, apparatus 1300 is a non-limiting example of a line compressor 1210 of FIG. 12.

Apparatus 1300 includes run-length encoding circuit 1302, gradient encoding logic circuit 1306, and image data 1308.

Run-length encoding circuit 1302 receives a portion of image data 1308 and encodes a portion of the portion of image data 1308 using gradient encoding and outputs the portion of the portion of image data encoded via gradient encoding. Gradient encoding circuit 1304 receives a portion of image data 1308 and encodes a portion of the portion of image data 1308 using run-length encoding and outputs the portion of the portion of image data encoded via run-length encoding. In one or more examples, run-length encoding circuit 1302 determines and provides one or more values that represent the number of pixels per run compressible via run-length encoding of the portion of the portion of image data 1308 and gradient encoding circuit 1304 determines and provides one or more values that represent the number of pixels per run compressible via gradient encoding of the portion of the portion of image data 1308. Logic circuit 1306 selects the highest number of pixels in a run compressible between run-length encoding circuit 1302 and gradient encoding circuit 1304, and logic circuit 1306 instructs the respective one of run-length encoding circuit 1302 and gradient encoding circuit 1304 to encode the respective portion of the portion of image data 1308 in accordance with the highest number of pixels in a run compressible via run-length encoding or gradient encoding. Logic circuit 1306 iteratively determines the highest number of pixels in a run compressible by run-length encoding circuit 1302 and gradient encoding circuit 1304 until the portion of image data 1308 has been encoded by one or more of run-length encoding circuit 1302 and gradient encoding circuit 1304.

As described above, logic circuit 1306 receives respective values representing the number of pixels in a run compressible from run-length encoding circuit 1302 and gradient encoding circuit 1304, determines the highest one of the numbers, and selectively encode the portion of line of image data 1308 corresponding the highest number of pixels in a run compressible via the one of run-length encoding circuit 1302 and gradient encoding circuit 1304 corresponding to the highest number. In one or more examples, 1306 may select the output of the one of run-length encoding circuit 1302 and gradient encoding circuit 1304 corresponding to the highest number be used as an encoded portion, which in combination, form line of image data 1308. Thus, the number of pixels in the run is defined by the highest number of pixels in a run compressible via the one of run-length encoding circuit 1302 and gradient encoding circuit 1304.

In one or more examples, logic circuit 1306 may perform some or a totality of operations of processes discussed above, including without limitation process 100, process 200, or process 900. In one or more examples, run-length encoding circuit 1302 may perform some or a totality of operations of processes discussed above, including without limitation process 300 or subroutine 1000. In one or more examples, gradient encoding circuit 1304 may perform some or a totality of operations of processes discussed above, including without limitation process 400 or system 1200.

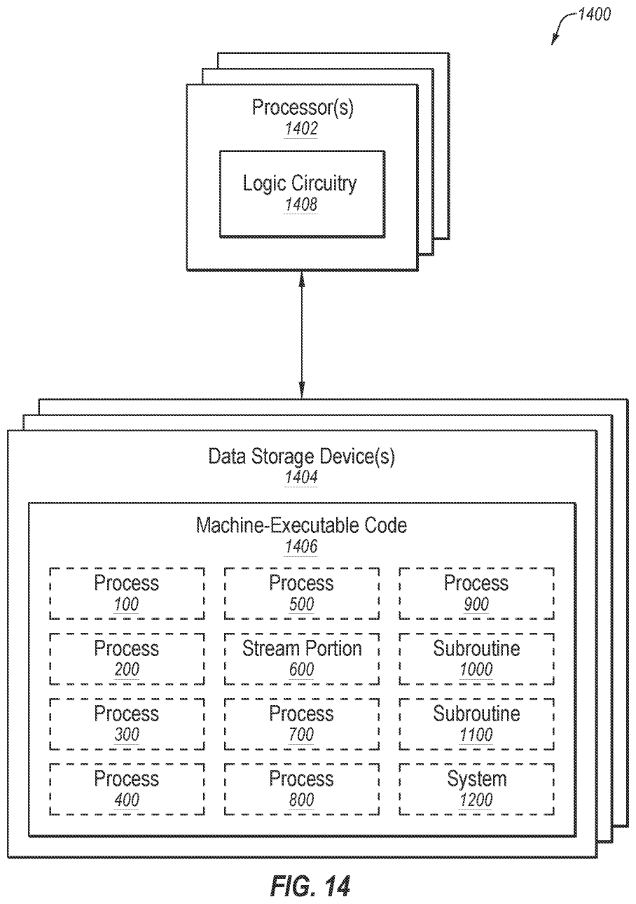

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 14 illustrates non-limiting examples of implementations of functional elements disclosed herein. In some embodiments, some or all portions of the functional elements disclosed herein may be performed by hardware specially configured for carrying out the functional elements.

FIG. 14 is a block diagram of circuitry 1400 that, in some embodiments, may be used to implement various functions, operations, acts, processes, and/or methods disclosed herein. The circuitry 1400 includes one or more processors 1402 (sometimes referred to herein as “processors 1402”) operably coupled to one or more data storage devices (sometimes referred to herein as “storage 1404”). The storage 1404 includes machine executable code 1406 stored thereon and the processors 1402 include logic circuitry 1408. The machine executable code 1406 includes information describing functional elements that may be implemented by (e.g., performed by) the logic circuitry 1408. The logic circuitry 1408 is adapted to implement (e.g., perform) the functional elements described by the machine executable code 1406. The circuitry 1400, when executing the functional elements described by the machine executable code 1406, should be considered as special purpose hardware configured for carrying out functional elements disclosed herein. In some embodiments the processors 1402 may perform the functional elements described by the machine executable code 1406 sequentially, concurrently (e.g., on one or more different hardware platforms), or in one or more parallel process streams.

When implemented by logic circuitry 1408 of the processors 1402, the machine executable code 1406 adapts the processors 1402 to perform operations of embodiments disclosed herein. For example, the machine executable code 1406 may adapt the processors 1402 to perform at least a portion or a totality of the operations of process 100, process 200, process 300, process 400, process 500, process 700, process 800, process 900, subroutine 1000, subroutine 1100, or system 1200. The machine executable code 1406 may adapt the processors 1402 to include, or perform at least a portion or a totality of the operations of, system 1200, encoding device 1202, and decoding device 1204.

The processors 1402 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executed functional elements corresponding to the machine executable code 1406 (e.g., software code, firmware code, hardware descriptions) related to embodiments of the present disclosure. It is noted that a general-purpose processor (may also be referred to herein as a host processor or simply a host) may be a microprocessor, but in the alternative, the processors 1402 may include any conventional processor, controller, microcontroller, or state machine. The processors 1402 may also be implemented as a combination of computing devices, such as a combination of a DSP and a microprocessor, a plurality of microprocessors, one or more microprocessors in conjunction with a DSP core, or any other such configuration.

In some embodiments the storage 1404 includes volatile data storage (e.g., random-access memory (RAM)), non-volatile data storage (e.g., Flash memory, a hard disc drive, a solid-state drive, erasable programmable read-only memory (EPROM), etc.). In some embodiments the processors 1402 and the storage 1404 may be implemented into a single device (e.g., a semiconductor device product, a system on chip (SOC), etc.). In some embodiments the processors 1402 and the storage 1404 may be implemented into separate devices.

In some embodiments the machine executable code 1406 may include computer-readable instructions (e.g., software code, firmware code). By way of non-limiting example, the computer-readable instructions may be stored by the storage 1404, accessed directly by the processors 1402, and executed by the processors 1402 using at least the logic circuitry 1408. Also by way of non-limiting example, the computer-readable instructions may be stored on the storage 1404, transferred to a memory device (not shown) for execution, and executed by the processors 1402 using at least the logic circuitry 1408. Accordingly, in some embodiments the logic circuitry 1408 includes electrically configurable logic circuitry 1408.

In some embodiments the machine executable code 1406 may describe hardware (e.g., circuitry) to be implemented in the logic circuitry 1408 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1408 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine executable code 1406 may include an HDL, an RTL, a GL description, a mask level description, other hardware description, or any combination thereof.

In embodiments where the machine executable code 1406 includes a hardware description (at any level of abstraction), a system (not shown, but including the storage 1404) may be configured to implement the hardware description described by the machine executable code 1406. By way of non-limiting example, the processors 1402 may include a programmable logic device (e.g., an FPGA or a PLC) and the logic circuitry 1408 may be electrically controlled to implement circuitry corresponding to the hardware description into the logic circuitry 1408. Also by way of non-limiting example, the logic circuitry 1408 may include hard-wired logic manufactured by a manufacturing system (not shown, but including the storage 1404) according to the hardware description of the machine executable code 1406.

Regardless of whether the machine executable code 1406 includes computer-readable instructions or a hardware description, the logic circuitry 1408 is adapted to perform the functional elements described by the machine executable code 1406 when implementing the functional elements of the machine executable code 1406. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method, comprising: for at least a portion of an image, determining a highest number of: a number of pixels in a run compressible via run-length encoding, and a number of pixels in a run compressible via gradient encoding; and selectively encoding at least some pixels of the image via the one of run-length encoding or gradient encoding corresponding to the determined highest number.

Example 2: The method according to Example 1, comprising: selectively encoding remaining pixels of the image via one or more of run-length encoding or gradient encoding at least partially based on respective determined highest numbers of pixels in runs compressible via run-length encoding or gradient encoding.

Example 3: The method according to any of Examples 1 and 2, comprising sending a transmission over a network, the transmission including the encoded image and an indicator bit, the indicator bit indicating an encoding scheme utilized to encode the encoded image, the encoding scheme indicatable by the indicator bit including run-length encoding and gradient encoding.

Example 4: The method according to any of Examples 1 through 3, wherein the determining the highest number of: the number of pixels in the run compressible via run-length encoding, and the number of pixels in the run compressible via gradient encoding comprises: determining the number of pixels in the run compressible via run-length encoding; determining the number of pixels in the run compressible via gradient encoding; and determining the highest number of: the number of pixels in the run compressible via run-length encoding, and the number of pixels in the run compressible via gradient encoding.

Example 5: The method according to any of Examples 1 through 4, wherein the determining the number of pixels in the run compressible via run-length encoding comprises: determining a number of pixels in a sequence having a same pixel value; and determining the number of pixels in the run compressible via run-length encoding at least partially based on the determined number of pixels in the sequence having the same pixel value.

Example 6: The method according to any of Examples 1 through 5, wherein the determining the number of pixels in the run compressible via gradient encoding comprises: determining a number of pixels in a sequence where a difference between adjacent pixel values is the same; and determining the number of pixels in the run compressible via gradient encoding at least partially based on the determined number of pixels in the sequence where the difference between adjacent pixel values in the sequence is the same.

Example 7: The method according to any of Examples 1 through 6, comprising, indicating the determined number of pixels where the difference between adjacent pixel values is the same is less than a first predetermined threshold.

Example 8: The method according to any of Examples 1 through 7, comprising, setting the determined number of pixels where the difference between adjacent pixel values is the same to zero in response to a determination that the determined number of pixels where the difference between adjacent pixel values is the same is less than a first predetermined threshold.

Example 9: The method according to any of Examples 1 through 8, comprising, indicating the difference between adjacent pixel values exceeds a second predetermined threshold.

Example 10: The method according to any of Examples 1 through 9, comprising, setting the determined number of pixels where the difference between adjacent pixel values is the same to zero in response to a determination that the difference between adjacent pixel values exceed a second predetermined threshold.

Example 11: The method according to any of Examples 1 through 10, wherein the selectively encoding at least some pixels of the image via the one of run-length encoding or gradient encoding corresponding to the determined highest number comprises: selectively encoding a remaining portion of the image via one or more of run-length encoding or gradient encoding.

Example 12: The method according to any of Examples 1 through 11, setting a value of an indicator bit of a transmission including an encoded portion of the image, the value of the indicator bit to indicate an encoding scheme utilized to encode the encoded portion of the image.

Example 13: An apparatus, comprising: at least one processor; and a memory to store machine-executable instructions that, upon execution by the at least one processor, enable the at least one processor to: determine a highest number of: a number of pixels in a run compressible via run-length encoding, and a number of pixels in a run compressible via gradient encoding; and selectively encode at least some pixels of an image via the one of run-length encoding or gradient encoding corresponding to the determined highest number.

Example 14: The apparatus according to Example 13, wherein the memory to store machine-executable instructions that, upon execution by the at least one processor, enable the at least one processor to: selectively encoding remaining pixels of the image via one or more of run-length encoding or gradient encoding at least partially based on respective determined highest numbers of pixels in runs compressible via run-length encoding or gradient encoding.

Example 15: The apparatus according to any of Examples 13 and 14, wherein the memory to store machine-executable instructions that, upon execution by the at least one processor, enable the at least one processor to: determine the number of pixels in the run compressible via run-length encoding; determine the number of pixels in the run compressible via gradient encoding; compare the determined number of pixels in the run compressible via run-length encoding and the determined number of pixels in the run compressible via gradient encoding; and responsive to the comparison: determine the highest number of: the number of pixels in the run compressible via run-length encoding, and the number of pixels in the run compressible via gradient encoding.

Example 16: The apparatus according to any of Examples 13 through 14, wherein the memory to store machine-executable instructions that, upon execution by the at least one processor, enable the at least one processor to: determine a number of pixels in a sequence having a same pixel value; and determine the number of pixels in a run compressible via run-length encoding at least partially based on the determined number of pixels in the sequence having the same pixel value.

Example 17: The apparatus according to any of Examples 13 through 16, wherein the memory to store machine-executable instructions that, upon execution by the at least one processor, enable the at least one processor to: determine a number of pixels in a sequence where a difference between adjacent pixel values is the same; and determine the number of pixels in a run compressible via gradient encoding at least partially based on the determined number of pixels in the sequence where the difference between adjacent pixel values in the sequence is the same.

Example 18: The apparatus according to any of Examples 13 through 17, wherein the memory to store machine-executable instructions that, upon execution by the at least one processor, enable the at least one processor to: set the determined number of pixels where a difference between adjacent pixel values is the same to zero in response to a determination that the determined number of pixels where the difference between adjacent pixel values is the same does not exceed a predetermined threshold.

Example 19: The apparatus according to any of Examples 13 through 28, wherein the memory to store machine-executable instructions that, upon execution by the at least one processor, enable the at least one processor to: indicate the determined number of pixels where the difference between adjacent pixel values is the same does not exceed a predetermined threshold.

Example 20: The apparatus according to any of Examples 13 through 19, wherein the memory to store machine-executable instructions that, upon execution by the at least one processor, enable the at least one processor to: set the determined number of pixels where a difference between adjacent pixel values is the same to zero in response to a determination that the determined number of pixels where the difference between adjacent pixel values is the same is less than a first predetermined threshold.

Example 21: The apparatus according to any of Examples 13 through 20, wherein the memory to store machine-executable instructions that, upon execution by the at least one processor, enable the at least one processor to: indicate that a determined number of pixels where the difference between adjacent pixel values is the same is less than a first predetermined threshold.

Example 22: An apparatus, comprising: a run-length encoding circuit; a gradient encoding circuit; and a logic circuit to: determine a highest number of: a number of pixels in a run compressible via run-length encoding, and a number of pixels in the run compressible via gradient encoding; and selectively encode at least some pixels of an image via the one of run-length encoding or gradient encoding corresponding to the determined highest number.

Example 23: The apparatus according to Example 22, wherein the run-length encoding circuit to determine the number of pixels in the run compressible via run-length encoding.

Example 24: The apparatus according to any of Examples 22 and 23, wherein, to determine the number of pixels in the run compressible via run-length encoding, the run-length encoding circuit to: determine a number of pixels in a sequence having a same pixel value; and determine the number of pixels in the run compressible via run-length encoding at least partially based on the determined number of pixels in the sequence having the same pixel value.

Example 25: The apparatus according to any of Examples 22 through 24, wherein the gradient encoding circuit to determine the number of pixels in the run compressible via gradient encoding.

Example 26: The apparatus according to any of Examples 22 through 25 wherein, to determine the number of pixels in the run compressible via gradient encoding, the gradient encoding circuit to: determine a number of pixels in a sequence where a difference between adjacent pixel values is the same; and determine the number of pixels in the run compressible via gradient encoding at least partially based on the determined number of pixels in the sequence where the difference between adjacent pixel values in the sequence is the same.

Example 27: The apparatus according to any of Examples 22 through 25, wherein the logic circuit to: selectively encode remaining pixels of the image via one or more of run-length encoding or gradient encoding at least partially based on respective determined highest numbers of pixels compressible in runs via run-length encoding or gradient encoding.

Example 28: The apparatus according to any of Examples 22 through 27, comprising a network equipment to send the image to a network, the image comprising a portion of image data encoded via run-length encoding and a portion of image data encoded via gradient encoding.

Example 29: The apparatus according to any of Examples 22 through 28, wherein the logic circuit to set a value of an indicator bit of a transmission including an encoded portion of the image, the value of the indicator bit to indicate an encoding scheme utilized to encode the encoded portion of the image.

Example 30: A method, comprising: determining an encoder scheme utilized to encode a portion of encoded image data at least partially responsive to an indicator bit included with the encoded image data, a state of the indicator bit to identify one of run-length encoding or gradient encoding; and decoding the portion of encoded image data using: run-length decoding responsive to the indicator bit indicating the portion of encoded image data was encoded using run-length encoding; or gradient decoding responsive to the indicator bit indicating the portion of encoded image data was encoded using gradient encoding.

Example 31: The method according to Example 30, comprising: obtaining a pixel value from the portion of encoded image data; and obtaining an encoded data length value from the portion of encoded image data.

Example 32: The method according to any of Examples 30 and 31, comprising: decoding the encoded image data utilizing the encoding scheme indicated by the indicator bit, the pixel value, and the encoded data length value.

Example 33: The method according to any of Examples 30 through 32, comprising: obtaining a further pixel value from a further portion of encoded image data; obtaining a further encoded data length value from a further portion of encoded image data; and decoding the further portion of encoded image data utilizing an encoding scheme indicated by a further indicator bit, the further pixel value, and the further encoded data length value, wherein the further indicator bit included with the further encoded image data.

Example 34: The method according to any of Examples 30 through 33, wherein the pixel value comprises a grayscale value or a color value.

Example 35: The method according to any of Examples 30 through 34, wherein the indicator bit settable to alternately indicate run-length encoding or gradient encoding.

Example 36: The method according to any of Examples 30 through 35, comprising: decoding remaining portions of the image data via one or more of run-length decoding or gradient decoding.

Example 37: An apparatus, comprising: at least one processor; and a memory having hardware-executable instructions stored thereon, wherein the instructions, upon execution by the at least one processor, enable the at least one processor to: determine an encoder scheme utilized to encode a portion of encoded image data at least partially responsive to an indicator bit included with the encoded image data, a value of the indicator bit to identify one of run-length encoding or gradient encoding; responsive to the determined encoder scheme, decode the portion of encoded image data utilizing: run-length decoding responsive to the indicator bit indicating the portion of encoded image data was encoded using run-length encoding; or gradient decoding responsive to the indicator bit indicating the portion of encoded image data was encoded using gradient encoding.

Example 38: The apparatus according to Example 37, comprising: run-length decoding circuitry to decode encoded image data using run-length decoding; and gradient decoding circuitry to decode encoded image data using gradient decoding.

Example 39: The apparatus according to any of Examples 37 and 38, wherein the indicator bit settable to alternately indicate run-length encoding or gradient encoding.

Example 40: The apparatus according to any of Examples 37 through 39, wherein the instructions, upon execution by the at least one processor, enable the at least one processor to: obtain a pixel value from the portion of encoded image data; and obtain an encoded data length value from the portion of encoded image data.

Example 41: The apparatus according to any of Examples 37 through 40, wherein the instructions, upon execution by the at least one processor, enable the at least one processor to: decode the encoded image data utilizing the encoding scheme indicated by the indicator bit, the pixel value, and the encoded data length value.

Example 42: The apparatus according to any of Examples 37 through 41, wherein the instructions, upon execution by the at least one processor, enable the at least one processor to: obtain a further pixel value from a further portion of encoded image data; obtain a further encoded data length value from a further portion of encoded image data; and decode the further portion of encoded image data utilizing an encoding scheme indicated by a further indicator bit, the further pixel value, and the further encoded data length value, wherein the further indicator bit included with the further encoded image data.

Example 43: The apparatus according to any of Examples 37 through 42, wherein the pixel value comprises a grayscale value or a color value.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A method, comprising:
for at least a portion of an image, determining a highest number of: a number of pixels in a run compressible via run-length encoding, and a number of pixels in a run compressible via gradient encoding; and
selectively encoding at least some pixels of the image via the one of run-length encoding or gradient encoding corresponding to the determined highest number.

2. The method of claim 1, comprising:
selectively encoding remaining pixels of the image via one or more of run-length encoding or gradient encoding at least partially based on respective determined highest numbers of pixels in runs compressible via run-length encoding or gradient encoding.

3. The method of claim 2, comprising sending a transmission over a network, the transmission including the encoded image and an indicator bit, the indicator bit indicating an encoding scheme utilized to encode the encoded image, the encoding scheme indicatable by the indicator bit including run-length encoding and gradient encoding.

4. The method of claim 1, wherein the determining the highest number of: the number of pixels in the run compressible via run-length encoding, and the number of pixels in the run compressible via gradient encoding comprises:
determining the number of pixels in the run compressible via run-length encoding;
determining the number of pixels in the run compressible via gradient encoding; and
determining the highest number of: the number of pixels in the run compressible via run-length encoding, and the number of pixels in the run compressible via gradient encoding.

5. The method of claim 4, wherein the determining the number of pixels in the run compressible via run-length encoding comprises:
determining a number of pixels in a sequence having a same pixel value; and
determining the number of pixels in the run compressible via run-length encoding at least partially based on the determined number of pixels in the sequence having the same pixel value.

6. The method of claim 4, wherein the determining the number of pixels in the run compressible via gradient encoding comprises:
determining a number of pixels in a sequence where a difference between adjacent pixel values is the same; and
determining the number of pixels in the run compressible via gradient encoding at least partially based on the determined number of pixels in the sequence where the difference between adjacent pixel values in the sequence is the same.

7. The method of claim 6, comprising, setting the determined number of pixels where the difference between adjacent pixel values is the same to zero in response to a determination that the determined number of pixels where the difference between adjacent pixel values is the same is less than a first predetermined threshold.

8. The method of claim 6, comprising, setting the determined number of pixels where the difference between adjacent pixel values is the same to zero in response to a determination that the difference between adjacent pixel values exceed a second predetermined threshold.

9. The method of claim 1, wherein the selectively encoding at least some pixels of the image via the one of run-length encoding or gradient encoding corresponding to the determined highest number comprises:
selectively encoding a remaining portion of the image via one or more of run-length encoding or gradient encoding.

10. The method of claim 1, setting a value of an indicator bit of a transmission including an encoded portion of the image, the value of the indicator bit to indicate an encoding scheme utilized to encode the encoded portion of the image.

11. An apparatus, comprising:
at least one processor; and
a memory to store machine-executable instructions that, upon execution by the at least one processor, enable the at least one processor to:
determine a highest number of: a number of pixels in a run compressible via run-length encoding, and a number of pixels in a run compressible via gradient encoding; and
selectively encode at least some pixels of an image via the one of run-length encoding or gradient encoding corresponding to the determined highest number.

12. The apparatus of claim 11, wherein the memory to store machine-executable instructions that, upon execution by the at least one processor, enable the at least one processor to:
selectively encoding remaining pixels of the image via one or more of run-length encoding or gradient encoding at least partially based on respective determined highest numbers of pixels in runs compressible via run-length encoding or gradient encoding.

13. The apparatus of claim 11, wherein the memory to store machine-executable instructions that, upon execution by the at least one processor, enable the at least one processor to:
determine the number of pixels in the run compressible via run-length encoding;
determine the number of pixels in the run compressible via gradient encoding;
compare the determined number of pixels in the run compressible via run-length encoding and the determined number of pixels in the run compressible via gradient encoding; and
responsive to the comparison: determine the highest number of: the number of pixels in the run compressible via run-length encoding, and the number of pixels in the run compressible via gradient encoding.

14. The apparatus of claim 13, wherein the memory to store machine-executable instructions that, upon execution by the at least one processor, enable the at least one processor to:
determine a number of pixels in a sequence having a same pixel value; and
determine the number of pixels in a run compressible via run-length encoding at least partially based on the determined number of pixels in the sequence having the same pixel value.

15. The apparatus of claim 12, wherein the memory to store machine-executable instructions that, upon execution by the at least one processor, enable the at least one processor to:
determine a number of pixels in a sequence where a difference between adjacent pixel values is the same; and
determine the number of pixels in a run compressible via gradient encoding at least partially based on the determined number of pixels in the sequence where the difference between adjacent pixel values in the sequence is the same.

16. The apparatus of claim 12, wherein the memory to store machine-executable instructions that, upon execution by the at least one processor, enable the at least one processor to:
set the determined number of pixels where a difference between adjacent pixel values is the same to zero in response to a determination that the determined number of pixels where the difference between adjacent pixel values is the same does not exceed a predetermined threshold.

17. The apparatus of claim 12, wherein the memory to store machine-executable instructions that, upon execution by the at least one processor, enable the at least one processor to:
set the determined number of pixels where a difference between adjacent pixel values is the same to zero in response to a determination that the determined number of pixels where the difference between adjacent pixel values is the same is less than a first predetermined threshold.

18. An apparatus, comprising:
a run-length encoding circuit;
a gradient encoding circuit; and
a logic circuit to:
determine a highest number of: a number of pixels in a run compressible via run-length encoding, and a number of pixels in the run compressible via gradient encoding; and
selectively encode at least some pixels of an image via the one of run-length encoding or gradient encoding corresponding to the determined highest number.

19. The apparatus of claim 18, wherein the run-length encoding circuit to determine the number of pixels in the run compressible via run-length encoding.

20. The apparatus of claim 19, wherein, to determine the number of pixels in the run compressible via run-length encoding, the run-length encoding circuit to:
determine a number of pixels in a sequence having a same pixel value; and
determine the number of pixels in the run compressible via run-length encoding at least partially based on the determined number of pixels in the sequence having the same pixel value.

21. The apparatus of claim 19, wherein the gradient encoding circuit to determine the number of pixels in the run compressible via gradient encoding.

22. The apparatus of claim 20, wherein, to determine the number of pixels in the run compressible via gradient encoding, the gradient encoding circuit to:
determine a number of pixels in a sequence where a difference between adjacent pixel values is the same; and
determine the number of pixels in the run compressible via gradient encoding at least partially based on the determined number of pixels in the sequence where the difference between adjacent pixel values in the sequence is the same.

23. The apparatus of claim 18, wherein the logic circuit to:
selectively encode remaining pixels of the image via one or more of run-length encoding or gradient encoding at least partially based on respective determined highest numbers of pixels compressible in runs via run-length encoding or gradient encoding.

24. The apparatus of claim 18, comprising a network equipment to send the image to a network, the image comprising a portion of image data encoded via run-length encoding and a portion of image data encoded via gradient encoding.

25. The apparatus of claim 18, wherein the logic circuit to set a value of an indicator bit of a transmission including an encoded portion of the image, the value of the indicator bit to indicate an encoding scheme utilized to encode the encoded portion of the image.

26. A method, comprising:
determining an encoder scheme utilized to encode a portion of encoded image data at least partially responsive to an indicator bit included with the encoded image data, a state of the indicator bit to identify one of run-length encoding or gradient encoding; and
decoding the portion of encoded image data using:
run-length decoding responsive to the indicator bit indicating the portion of encoded image data was encoded using run-length encoding; or
gradient decoding responsive to the indicator bit indicating the portion of encoded image data was encoded using gradient encoding.

27. The method of claim 26, comprising:
obtaining a pixel value from the portion of encoded image data; and
obtaining an encoded data length value from the portion of encoded image data.

28. The method of claim 27, comprising:
decoding the encoded image data utilizing the encoding scheme indicated by the indicator bit, the pixel value, and the encoded data length value.

29. The method of claim 27, comprising:
obtaining a further pixel value from a further portion of encoded image data;
obtaining a further encoded data length value from a further portion of encoded image data; and
decoding the further portion of encoded image data utilizing an encoding scheme indicated by a further indicator bit, the further pixel value, and the further encoded data length value, wherein the further indicator bit included with the further encoded image data.

30. The method of claim 27, wherein the pixel value comprises a grayscale value or a color value.

31. The method of claim 26, wherein the indicator bit settable to alternately indicate run-length encoding or gradient encoding.

32. The method of claim 27, comprising:
decoding remaining portions of the image data via one or more of run-length decoding or gradient decoding.

33. An apparatus, comprising:
at least one processor; and
a memory having hardware-executable instructions stored thereon, wherein the instructions, upon execution by the at least one processor, enable the at least one processor to:
determine an encoder scheme utilized to encode a portion of encoded image data at least partially responsive to an indicator bit included with the encoded image data, a value of the indicator bit to identify one of run-length encoding or gradient encoding;
responsive to the determined encoder scheme, decode the portion of encoded image data utilizing:
run-length decoding responsive to the indicator bit indicating the portion of encoded image data was encoded using run-length encoding; or
gradient decoding responsive to the indicator bit indicating the portion of encoded image data was encoded using gradient encoding.

34. The apparatus of claim 33, comprising:
run-length decoding circuitry to decode encoded image data using run-length decoding; and
gradient decoding circuitry to decode encoded image data using gradient decoding.

35. The apparatus of claim 33, wherein the indicator bit settable to alternately indicate run-length encoding or gradient encoding.

36. The apparatus of claim 33, wherein the instructions, upon execution by the at least one processor, enable the at least one processor to:
obtain a pixel value from the portion of encoded image data; and
obtain an encoded data length value from the portion of encoded image data.

37. The apparatus of claim 36, wherein the instructions, upon execution by the at least one processor, enable the at least one processor to:
decode the encoded image data utilizing the encoding scheme indicated by the indicator bit, the pixel value, and the encoded data length value.

38. The apparatus of claim 36, wherein the instructions, upon execution by the at least one processor, enable the at least one processor to:
obtain a further pixel value from a further portion of encoded image data;
obtain a further encoded data length value from a further portion of encoded image data; and
decode the further portion of encoded image data utilizing an encoding scheme indicated by a further indicator bit, the further pixel value, and the further encoded data length value, wherein the further indicator bit included with the further encoded image data.

39. The apparatus of claim 36, wherein the pixel value comprises a grayscale value or a color value.
